(19) United States
(12) Patent Application Publication
(10) Pub. No.: US 2023/0032524 A1
(43) Pub. Date: Feb. 2, 2023

(54) SHARING DEVICE AND PROXIMAL ACCESS METHOD THEREOF

(71) Applicant: FLH Co., Ltd., Taipei (TW)

(72) Inventors: Hou-Chun LEE, Taipei (TW); Ke-Wei WANG, Taipei (TW); Kuo-Chan HUANG, Taipei (TW)

(21) Appl. No.: 17/669,890

(22) Filed: Feb. 11, 2022

(30) Foreign Application Priority Data
Jul. 29, 2021 (TW) 110127983

(51) Int. Cl. H04L 9/40; H04W 76/14

(52) U.S. Cl. CPC H04L 63/10; H04W 76/14

(57) ABSTRACT

A sharing device and a proximal access method thereof are provided. Via the first communication unit with a smaller effective communication range, the portable electronic device can obtain control of the sharing device at a closer location and obtain the connection information of the second communication unit. Later, through the second communication unit with a larger effective communication range, the portable electronic device can conveniently control the sharing device. In this way, it is possible to avoid mishandling other sharing devices in the same space when initially gaining control, and to allow users to extend the distance of use after gaining control, which has both access security and convenience.

### CROSS-REFERENCE TO RELATED APPLICATIONS

This application is based upon and claims priority under 35 U.S.C. 119 from Taiwan Patent Application No. 110127983 filed on Jul. 29, 2021, which is hereby specifically incorporated herein by this reference thereto.

### BACKGROUND OF THE INVENTION

### 1. Field of the Invention

The present invention relates to a sharing device, especially to a proximal access method thereof.

### 2. Description of the Prior Arts

In the past, most of the employees work in the fixed offices. The employees work together on the premises purchased or leased by the company, which is convenient for centralized management and interactive communication. In recent years, as the industrial structure has changed, the working environment has also changed. Especially in the age of the rise of micro-entrepreneurship and the prevalence of multinational internet businesses, the non-fixed office environment gradually takes a place. There are many shared offices in the market, and users can use the office equipment in the shared offices within a certain period of time as long as they pay rent.

Generally speaking, an individual user rents one of the seats in the shared office and uses the desk and office chair of that seat. Based on the consideration of human health, standing for a period of time at work is good for health. Thus, many shared offices begin to provide lifting tables to attract users in need to rent. However, compared with ordinary desks with no additional functions, desks with a lifting function have more operations that need to control the lifting or other functions.

However, in a shared office, there is generally not only a single sharing desk, but multiple ones are often placed for multiple people to use. If the common wireless transmission methods are used, it is difficult to guarantee those different users who use sharing desks in different locations accidentally control other adjacent sharing desks in the same space. Therefore, it is inconvenient to use and manage the sharing desks in the same space.

### SUMMARY OF THE INVENTION

To overcome the shortcomings, the present invention provides a proximal access method of a sharing device to mitigate or to obviate the aforementioned problems.

A sharing device and a proximal access method thereof are provided. Via the first communication unit with a smaller effective communication range, the portable electronic device can obtain control of the sharing device at a closer location and obtain the connection information of the second communication unit. Later, through the second communication unit with a larger effective communication range, the portable electronic device can conveniently control the sharing device. In this way, it is possible to avoid mishandling other sharing devices in the same space when initially gaining control, and to allow users to extend the distance of use after gaining control, which has both access security and convenience.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a portable electronic device, a router and a sharing device in accordance with the present invention connecting to each other;

FIG. 2 is a block diagram of a portable electronic device, a router and a sharing device in accordance with the present invention connecting to each other;

FIG. 3 is a flowchart of the sharing device in FIG. 2 connecting to the portable device;

FIG. 4 is an illustrative view of the sharing device in FIG. 2 having the portable electronic device thereon;

FIG. 5 is an illustrative view of the sharing device in FIG. 2 having the portable electronic device departing from the sharing device;

FIG. 6 is another flowchart of the sharing device in FIG. 2 connecting to the portable device; and

FIG. 7 is a flowchart of a proximal access method of a sharing device in accordance with the present invention.

### DETAILED DESCRIPTION OF THE EMBODIMENTS

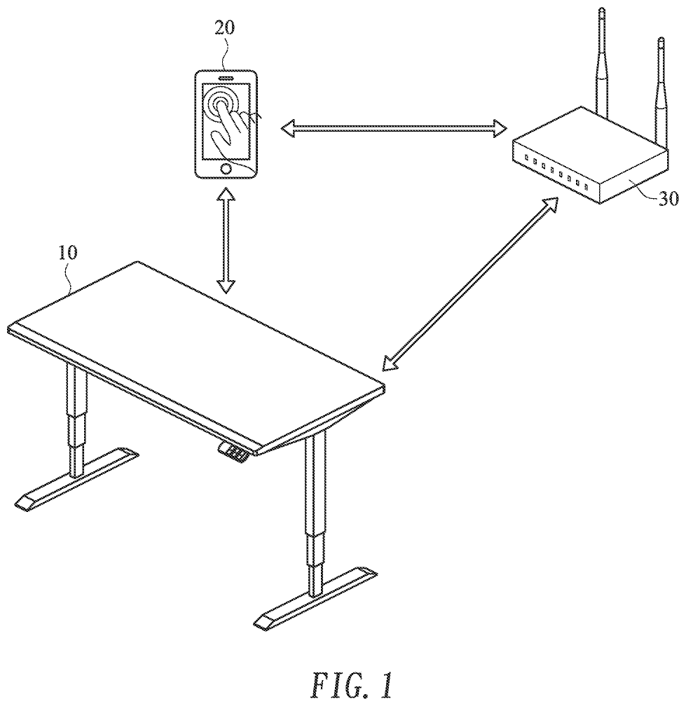

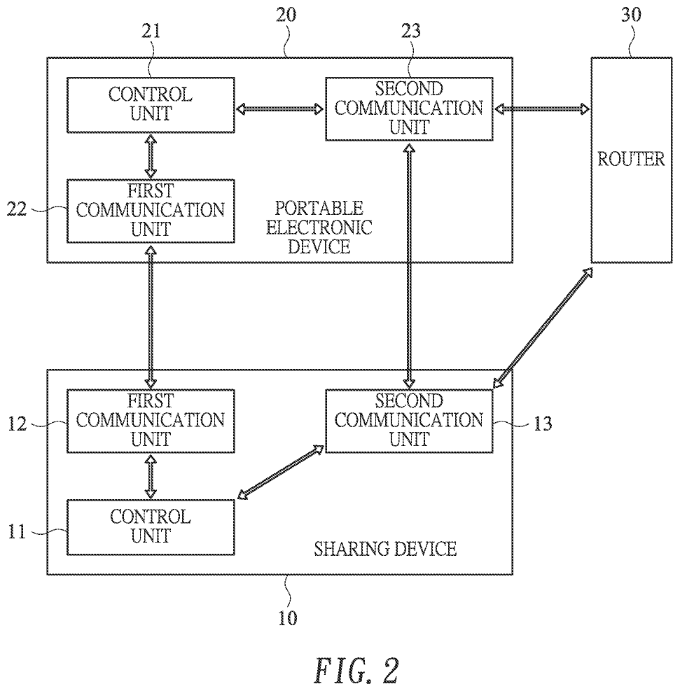

With reference to FIGS. 1 and 2, a sharing device 10 in accordance with the present invention comprises a control unit 11, a first communication unit 12, and a second communication unit 13. The first communication unit 12 and the second communication unit 13 are electrically connected to the control unit 11. The first communication unit 12 is a near-end wireless communication unit with an effective communication range equal to or less than one meter, such as a near-field communication (NFC) unit. The second communication unit 13 is a remote communication unit with an effective communication range greater than one meter and may be a wireless communication unit (such as Wi-Fi, Bluetooth, etc.)

The portable electronic device 20 comprises a control unit 21, a first communication unit 22, and a second communication unit 23. The first communication unit 22 and the second communication unit 23 are electrically connected to the control unit 21. The first communication unit 22 is a near-end wireless communication unit with an effective communication range equal to or less than one meter, such as a near-field communication (NFC) unit. The second communication unit 23 is a remote communication unit with an effective communication range greater than one meter and may be a wireless communication unit, such as wireless fidelity (Wi-Fi) communication unit, Bluetooth unit, a second-generation (2G) wireless unit, a third-generation (3G) wireless unit, a fourth-generation (4G) wireless unit, or a fifth-generation (5G) wireless unit or other mobile communication protocols, etc.

In one embodiment, the second communication unit 13 of the sharing device 10 and the second communication unit 23 of the portable electronic device 20 are directly connected (for example, Bluetooth) after obtaining connection information, and transmit messages directly after connecting to each other. In another embodiment, in the space of the sharing device 10, a wireless router 30 is used for connecting with the second communication unit 13 of the sharing device 10 and the second communication unit 23 of the portable electronic device 20 through wireless signals. After the portable electronic device 20 obtains the connection information of the router 30, the portable electronic device 20 and the sharing device 10 transmit messages through the connection between the second communication units 13 and 23 and the router 30.

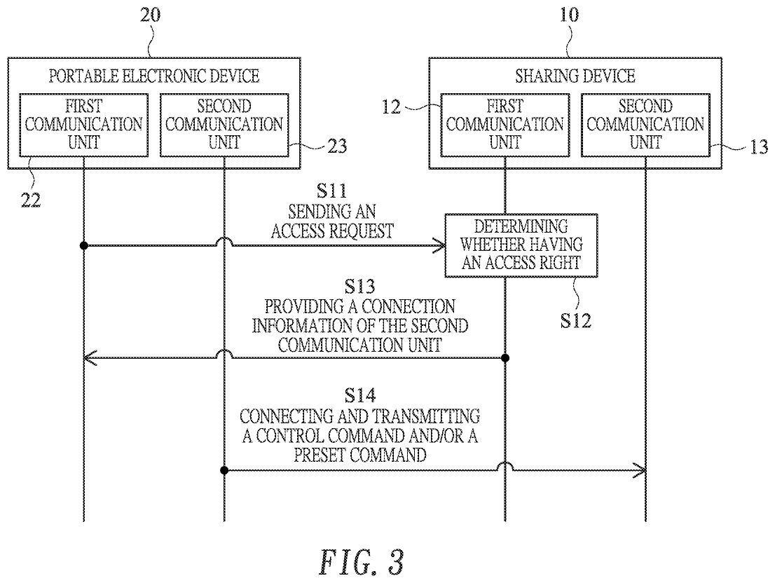

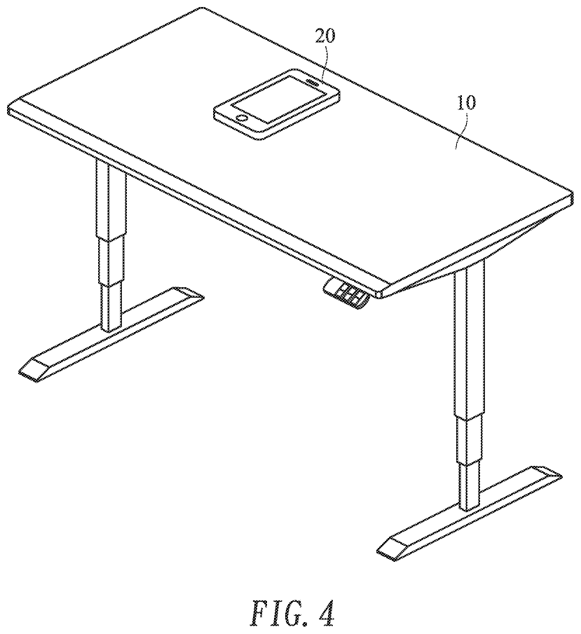

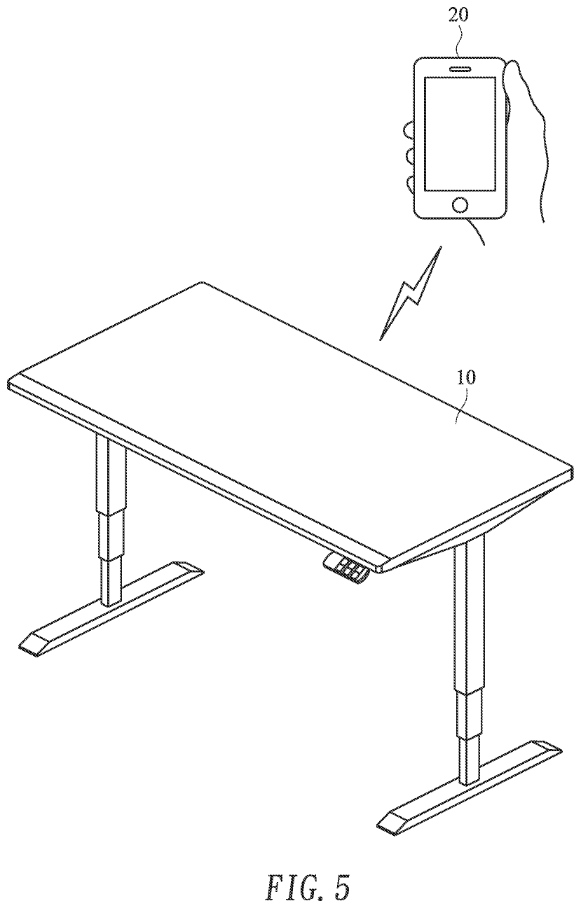

With reference to FIGS. 2 and 3, when the distance between the portable electronic device 20 and the sharing device 10 is less than one meter (for example, the portable electronic device 20 as shown in FIG. 4 is placed on the sharing device 10), the portable electronic device 20 enters the effective communication range of the first communication unit 12 of the sharing device 10. At this time, the first communication unit 22 of the portable electronic device 20 is connected to the first communication unit 12 of the sharing device 10, and an access request is sent to the sharing device 10 through the first communication units 12 and 22 (S11). The access request may include an authorization information of the portable electronic device 20. In one embodiment, the access request includes personalized information, such as user ID, etc. The control unit 11 of the sharing device 10 confirms whether the portable electronic device 20 has the access right according to the authorization information in the access request (S12). When it is confirmed that the portable device 20 has access rights, the portable electronic device 20 is allowed to control the shared device 10. The sharing device 10 provides connection information of the second communication unit 13 of the sharing device 10 through the connection of the first communication units 12 and 22 (S13). In one embodiment, the second communication unit 13 can be directly connected and controlled, and the connection information includes control information of the second communication unit 13 of the sharing device 10. For example, the connection information includes a service set identifier (SSID), a media access control address (Mac address), and a password of the second communication unit 13. Since the portable electronic device 20 has obtained the connection information of the second communication unit 13 of the sharing device 10, the portable electronic device 20 can subsequently control the sharing device 10 through the connection of the second communication units 23 and 13 (S14) as shown in FIG. 5. In one embodiment, the user may store the setting value of different lifting heights in the portable electronic device 20 for different scenarios. For example, the user stores the height of the sharing device 10 required for standing, sitting down, or relaxing (such as dining or watching a movie) in the portable electronic device 20. When the portable electronic device 20 obtains the control right of the sharing device 10, the setting values are transmitted to the sharing device 10 through the connection of the second communication units13, 23. When the user controls the sharing device 10, the user does not need to re-enter the required height. As long as the user enters a preset command, such as standing, sitting, or relaxing, the sharing device 10 adjusts to the desired height according to the stored setting values. Thus, the users may quickly use the heights they are accustomed to using when using different sharing devices at different times.

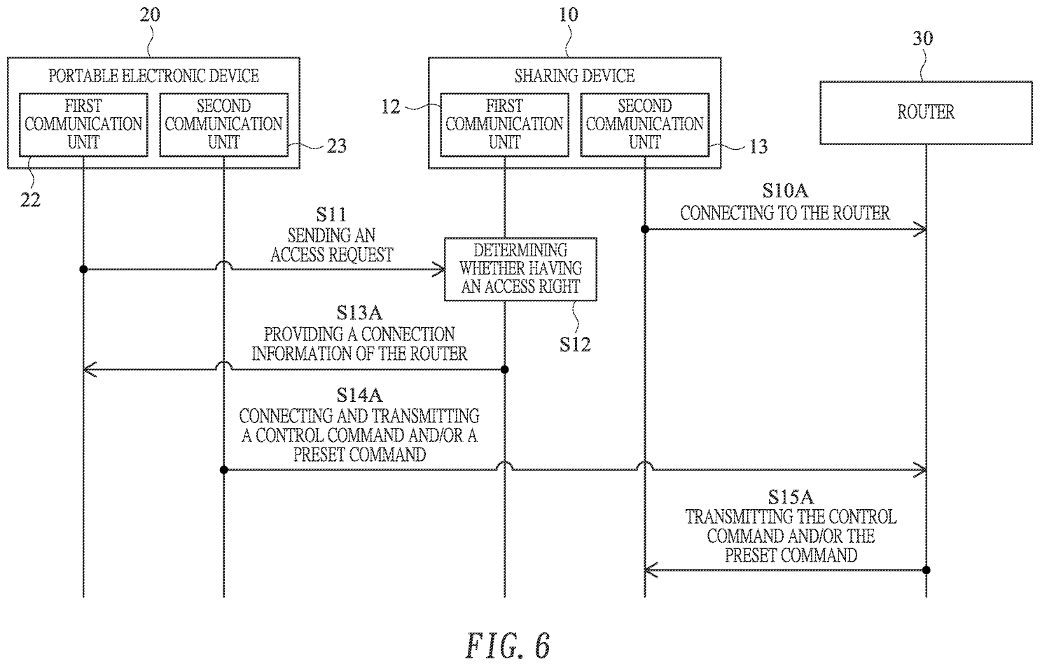

With reference to FIG. 6, in another embodiment, the second communication unit 13 of the sharing device 10 is connected and controlled through the router 30. The second communication unit 13 of the sharing device 10 is connected to the router 30 in the initial state (S10A). Then the connection information sent in the step S13A includes the service set identifier (SSID) of the router 30, the media access control address (Mac address) of the router 30, a login account, and a password of the router 30, etc. After the portable electronic device 20 obtains the connection information of the router 30, the portable electronic device 20 connects to the router 30 and sends control commands and preset commands to the router 30 (S14A). The sharing device 10 receives the control command and the preset command transmitted by the router 30 through the second communication unit 13 (S15A).

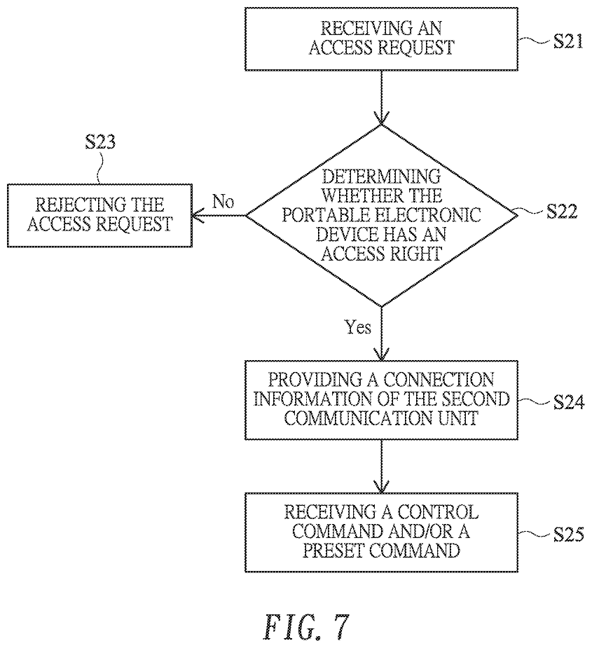

With reference to FIGS. 2 and 7, in summary, a proximal access method in accordance with the present invention executed by the sharing device 10 is described as follows:

S21: Receiving an access request through the first communication unit 12, wherein the access request may include authorization information of the portable electronic device 20.

S22: Determining whether the portable electronic device 20 has an access right according to the access request.

S23: Rejecting the access request if the portable electronic device 20 does not have the access right.

S24: Sending a connection information of the second communication unit 13 through the first communication unit 12 to the portable electronic device 20 if the portable electronic device 20 has the access right, wherein the portable electronic device 20 can subsequently control the sharing device 10 through the connection of the second communication units 23 and 13.

S25: Receiving a control command or a preset command through the second communication unit 13.

Therefore, the portable electronic device 20 connects to the first communication unit 12 of the sharing device 10 through the first communication unit 22 to obtain the access right, and then connects to the sharing device 10 through the second communication units 23 and 13 to control the sharing device 10. Since the effective communication range of the first communication units 12 and 22 is less than one meter, the user is effectively restricted from being able to obtain the access right in a very small range at the beginning, thereby avoiding the problem of incorrectly controlling the neighboring sharing devices 10. Furthermore, the connection information of the second communication unit 13 of the sharing device 10 can be obtained through the connection of the first communication units 12 and 22. The portable electronic device 20 subsequently controls the shared device 10 through the direct or indirect connection of the second communication units 23 and 13. Therefore, after the user obtains the control right and the connection information of the second communication unit 13, 23 through the first communication unit 12, 22 with a smaller communication range, the sharing device 10 then can be controlled through the connection of the second communication unit 13, 23 with a larger communication range. Since the effective communication range of the second communication units 13 and 23 is relatively large, it is convenient for the user to use it later.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sharing device comprising:
a control unit;
a first communication unit electrically connecting to the control unit, and being a near-end wireless communication unit with an effective communication range equal to or less than one meter; and
a second communication unit electrically connecting to the control unit, and being a remote communication unit with an effective communication range greater than one meter, wherein the control unit executes following steps
a. receiving an access request from a portable electronic device through the first communication unit;
b. determining if the portable electronic device has an access right;
c. rejecting the access request if the portable electronic device is determined as not having the access right;
d. transmitting a connection information of the second communication unit through the first communication unit if the portable electronic device is determined as having the access right; and
e. receiving a control command from the portable electronic device through the second communication unit.

2. The sharing device as claimed in claim 1, wherein the first communication unit is a near-field communication unit.

3. The sharing device as claimed in claim 1, wherein the second communication unit is a wireless communication unit including one of a wireless fidelity (Wi-Fi) communication unit, Bluetooth unit, a second-generation (2G) wireless unit, a third-generation (3G) wireless unit, a fourth-generation (4G) wireless unit, or a fifth-generation (5G) wireless unit.

4. The sharing device as claimed in claim 1, wherein the sharing device has a lifting function; in the step e, the control unit receives a setting value of a preset command from the portable electronic device through the second communication unit; and the control unit automatically adjusts a height of the sharing device to the height corresponding to the setting value when receives the preset command.

5. A proximal access method of a sharing device comprising steps of:
a. receiving an access request from a portable electronic device by the sharing device through a first communication unit of the sharing device, wherein the first communication unit has an effective communication range equal to or less than one meter;
b. determining by the sharing device if the portable electronic device has an access right;
c. rejecting the access request by the sharing device if the portable electronic device is determined as not having the access right;
d. transmitting a connection information of a second communication unit of the sharing device by the sharing device to the portable electronic device through the first communication unit of the sharing device if the portable electronic device is determined as having the access right, wherein the second communication unit has an effective communication range larger than one meter; and
e. receiving a control command from the portable electronic device by the sharing device through the second communication unit of the sharing device.

6. The proximal access method as claimed in claim 5, wherein the connection information of the second communication unit of the sharing device in the step d includes a service set identifier, a mac address and a password of the second communication unit of the sharing device.

7. The proximal access method as claimed in claim 5, wherein the connection information of the second communication unit of the sharing device in the step d includes a service set identifier, a mac address, a login account and a password of a router connecting to the second communication unit of the sharing device.

8. The proximal access method as claimed in claim 5, wherein the access request in the step a includes an information of the portable electronic device.

9. The proximal access method as claimed in claim 5, wherein in the step e, the sharing device receives a setting value of a preset command from the portable electronic device through the second communication unit; and the sharing device automatically adjusts a height of the sharing device to the height corresponding to the setting value when receives the preset command.

10. The proximal access method as claimed in claim 6, wherein in the step e, the sharing device receives a setting value of a preset command from the portable electronic device through the second communication unit; and the sharing device automatically adjusts a height of the sharing device to the height corresponding to the setting value when receives the preset command.

11. The proximal access method as claimed in claim 7, wherein in the step e, the sharing device receives a setting value of a preset command from the portable electronic device through the second communication unit; and the sharing device automatically adjusts a height of the sharing device to the height corresponding to the setting value when receives the preset command.

12. The proximal access method as claimed in claim 8, wherein in the step e, the sharing device receives a setting value of a preset command from the portable electronic device through the second communication unit; and the sharing device automatically adjusts a height of the sharing device to the height corresponding to the setting value when receives the preset command.
